(19) United States
(12) Patent Application Publication
(10) Pub. No.: US 2012/0151195 A1
(43) Pub. Date: Jun. 14, 2012

(54) ONBOARD COMPUTER WITH MODE S TRANSMISSION

(75) Inventors: Julien Damblemont, Colombes (FR); Patrick Erny, Colombes (FR)

(73) Assignee: THALES, Neuilly Sur Seine (FR)

(21) Appl. No.: 13/314,540

(22) Filed: Dec. 8, 2011

(30) Foreign Application Priority Data
Dec. 8, 2010 (FR) 10 04790

(51) Int. Cl. G06F 15/177

(52) U.S. Cl. 713/1

(57) ABSTRACT

An onboard computer for an airplane, including: a processor able to carry out operational functions according to a configuration of the onboard computer; a means for storing the configuration of the onboard computer; a means for parameterizing the onboard computer from parameterization information; a mode S transmission chain as defined by the ICAO for transmitting operational data from the onboard computer to or from a ground station or another airplane, the operational data being processed by the operational functions carried out by the computer. The transmission chain is able to carry out, in mode S, the transmission of parameterization information, to or from the parameterization means.

### CROSS REFERENCE TO PRIOR APPLICATIONS

The present application claims priority under 35 U.S.C. §119 to French Patent Application No. 1004790, filed on Dec. 8, 2010, which is incorporated herein by reference.

### FIELD OF THE INVENTION

The present invention relates to an onboard computer for an airplane, including a processor able to carry out operational functions according to a configuration of the onboard computer a means for storing the configuration of the onboard computer a means for parameterizing the onboard computer from parameterization information, and a mode S transmission chain as defined by the ICAO for transmitting operational data from the onboard computer to or from a ground station or another airplane, the operational data being processed by the operational functions carried out by the computer.

### BACKGROUND

Airplanes of all types are equipped with onboard computers including transponders enabling communication with ground stations or between airplanes.

These onboard computers are able to transmit in particular the altitude and identification code of the plane, possibly completed by a GPS position thereof.

This information is sent upon request or regularly from the onboard computer.

These computers traditionally use the Mode S protocol to communicate with the ground control stations or other airplanes in the 1030 to 1090 MHz frequency range. Mode S is defined in document “Annex 10 to the Convention on International Civil Aviation” by the International Civil Aviation Organization.

These onboard computers must sometimes be reconfigured to adapt to the existing platforms, activate/deactivate specific functions according to missions, or work in a specific mode such as maintenance mode and thus download new software needed for maintenance operations. These maintenance operations must be done on the ground while the airplane is immobilized.

To that end, it is known to equip onboard computers with a connector and with a maintenance-specific interface allowing a piece of maintenance equipment, such as a laptop computer allowing the exchange of information with the onboard computer, to be connected.

This maintenance-specific connector is associated in the onboard computer with a communication interface allowing a two-way transmission of information with the laptop computer serving for maintenance.

In order to avoid any malfunction, it is known to provide, in the onboard computer, means such that the connection to the maintenance connector makes the computer transition to maintenance mode, thereby prohibiting it from receiving or sending any information in mode S.

The communication bus used for maintenance is for example specified in standards ARINC 615 or 429 for civil aviation applications, standard MIL-STD-1553B for military applications, and Ethernet or the JTAG bus for proprietary applications.

This maintenance mode for the onboard computers operates correctly, but it is relatively long to implement and leads to expensive computers.

Lastly, these maintenance modes only make it possible to work on the computer when stopped, thereby making it impossible to obtain readings on the operating mode of the computer when it is in use.

### SUMMARY

The invention aims to propose an onboard computer enabling easier maintenance and whereof the maintenance-specific means are less expensive.

To that end, the invention relates to an onboard computer of the aforementioned type, characterized in that the transmission chain is able to carry out, in mode S, the transmission of parameterization information, to or from the parameterization means.

According to particular examples, the onboard computer includes one or more of the following features:
the parameterization means of the computer include maintenance means capable of modifying the configuration of the onboard computer and the parameterization information is maintenance information sent to or from the maintenance means;
the mode S transmission chain is configured to have a transmission rate for the maintenance data higher than the transmission rate for the operational data;
the transmission frequency for mode S maintenance data segments is greater than 100 Hz;
the transmission chain includes a processor having separate means for processing operational data and maintenance data and the onboard computer includes exclusive activation means, either for the operational data processing means, in an operational mode, or for the maintenance data processing means, in a maintenance mode;
the transmission chain is able to perform level 2 mode S transactions of the COMM-A/COMM-B type with long queries/responses among the reserve formats defined by the ICAO;
the parameterization means of the computer include means for allocating, in response to a predefined allocation request, an available registry as defined by the ICAO to a memory address of the computer whereof the value must be sent by the mode S transmission chain as additional operational data contained in the allocated registry and the parameterization information is at least one predefined allocation request sent to the allocation means;
the allocation request includes addresses and associated registries and the allocation means are able to allocate the associated registry to each address;
the computer includes a memory for configurations and each configuration specifies a set of addresses of the computer, and the allocation request includes an identification of a configuration and an associated registry and the allocation means are configured to allocate the associated registry to all of the addresses specified by the configuration such that the simultaneous values of all of the addresses of the configuration are transmitted together in mode S as operational data;
the computer includes memory for processes and each process specifies an address of the computer, and the allocation request includes an identification of a process and an associated registry and the allocation means are configured to allocate the associated registry to the specific identification address of the process so that the value of the address of the process is sent in mode S as operational data.

The invention also relates to a facility including:
an onboard computer as described above; and
a piece of maintenance equipment configured to communicate, according to a mode S connection, with the onboard computer by exchanging maintenance data.

### BRIEF DESCRIPTION OF THE DRAWINGS

The invention will be better understood upon reading the following description, provided solely as an example and done in reference to the drawings, in which:

FIG. 1 is a diagrammatic view of an onboard computer according to an example of the invention;

FIGS. 2 and 3 are diagrams illustrating data transfers between the onboard computer and a piece of maintenance equipment, and

FIG. 4 is a diagram illustrating the data transfers between the onboard computer and a piece of monitoring equipment.

### DETAILED DESCRIPTION

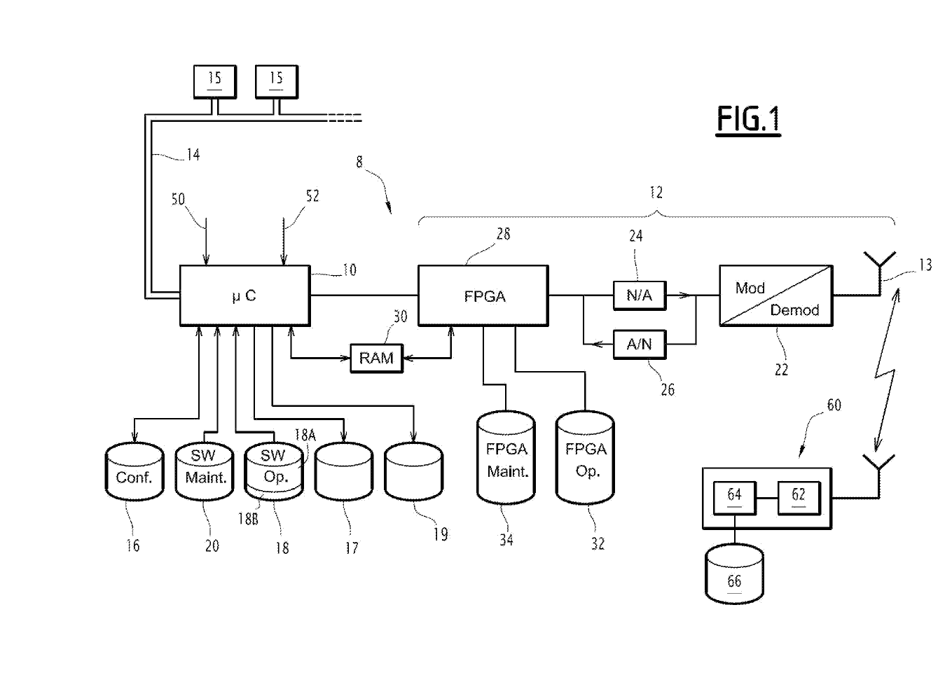

The onboard computer 8 illustrated in FIG. 1 is for example a Mode S transponder (answerer).

It includes a processor 10 such as a micro-processor associated with an information transmission chain 12 through an antenna 13. As is known in itself, the processor 10 is connected by an information transfer bus 14 to a set of equipment 15 of the airplane such as an altimeter, a satellite positioning system, or other.

The processor 10 is associated with a set of memories including configuration data 16, a flight event recording area 17 (breakdowns, real-time navigational data), operational processing software 18 carrying out the normal operation of the computer, an address-registry look-up table 19, and maintenance software 20 carrying out the management of the maintenance operations, in particular to modify the configuration 16, or load operational processing software.

The transmission chain 12 includes, in a known manner, from the antenna 13, a modulator/demodulator 22 followed by a digital/analog converter 24 and an analog/digital converter 26 mounted in parallel and able to convert the signal depending on the direction of the communication.

It than includes a processor 28 such as a processing processor for FPGA-type signals that can process the information sent from or to the computer and convert it into a format that can be interpreted by the processor 10 or that can be transmitted from the antenna 13. A buffer memory 30, for example made up of a RAM and forming shared messaging, carries out communication between the processor 10 and the processor 28.

The processor 28 includes a programmed area 32 that can manage the operational transmissions diagrammed in FIG. 1 through data storage.

As is known in itself, the operational area 32 of the processor 28 can receive and transmit information in mode S through the antenna 13 or shape the information received in mode S to make it interpretable by the processor 10. The operational area 32 of the processor 28 and the operational processing software 18 of the processor 10 distribute the processing so as to implement the functionalities of the mode S transponder according to the provisions of document “Annex 10 to the Convention on International Civil Aviation Organization” by the International Civil Aviation Organization (ICAO).

In particular, the operational processing software 18 carries out, from data stored in the table 19, the creation of response messages DF by placing, in the identified registries, the values contained in the corresponding memory addresses as defined by table 19.

To that end, the table 19 has, for each registry allocated to a datum according to the provisions of the ICAO, the address at which the datum is present if that address exists in the computer. Many registries are left unallocated in the ICAO provision and therefore a priori do not have corresponding addresses.

The operational processing software 18 includes a module 18A for managing mode S transmission that can carry out the interpretation of the ascending messages received in mode S (UF queries) and establishment of descending mode S response messages (DF responses) then sent by the transmission chain 12 to the ground.

This transmission is preferably done in mode S level 2, which is the minimum level required for a mode S transponder. The transaction transmitted by a mode S interrogator (ground station, military or surveillance aircraft) is done in COMM-A via long queries UF20 or UF21. In the descending direction, i.e. from the airplane to the querying station, the mode S transmission protocol used is called COMM-B. The data transfers are done via long responses DF20 or DF21, the data being updated in the 56 bit MB field contained in each of these responses. Respectively, in the ascending direction, the mode S transmission protocol used is called COMM-A. In COMM-A transmission, it is the queries UF20 or UF21 that allow the transfer of data, by updating the MA field contained in each of the queries and which is also 56 bits long.

The rhythm of the transmissions, and in particular the transmission frequency of the messages, is governed, as is known in itself, by the processor 28. The query and response segments in mode S are 34 microseconds and 120 microseconds, respectively. The query frequency is equal to 60 Hz or less for the transmission of information between the onboard computer and a ground station or another airplane.

According to the invention, the transmission chain 12 includes means for transmitting maintenance information in mode S to and from a dedicated piece of maintenance equipment 60 that can establish a short-range mode S communication solely for maintenance purposes.

To that end, the processor 28 includes a processing area 34 specifically for processing maintenance information diagrammed in FIG. 1 by data storage.

The processor 10 includes a means for switching the processor 28 from an operational state in which it implements only its operational area 32 to a maintenance mode in which it implements only its maintenance area 34. This means also ensures switching of the processor 10 itself to apply either the operational processing software 18, or the maintenance software 20.

To that end, the processor 10 has an input 50 for connecting to a status sensor for the landing gear that can detect that the landing gear is deformed and the airplane is therefore resting on the ground. It also includes an input 52 for maintenance control information that can be activated by an operator.

When the two conditions are met, i.e. the airplane is detected as being on the ground and maintenance information is detected on the input 52, the processor 10 and the processor 28 are switched into maintenance mode.

In that mode, the transmission chain 32 can receive and send queries and responses in mode S at a frequency higher than the operational transmission frequency of the information. It is in particular above 100 Hz, preferably above 1000 Hz, and less than 5000 Hz. To that end, the digital/analog 24 and analog/digital 26 converters, as well as the processor 28 and the modulation means 22, are adapted for rapid data processing.

The equipment 60 includes a mode S transmission chain 62 of the same type as the chain 12 but provided without an operational processing area 32. This transmission chain can transmit over short distances, i.e. a distance smaller than 1 km.

The equipment also has an information processing unit 64 and a storage means 66 for maintenance information to be transmitted or received from the onboard computer.

The maintenance data is sent in mode S using the 83 bits available in the reserve query formats. From the equipment 60 to the computer 10, the maintenance data are transmitted in mode S using the reserve query formats defined in document “ICAO Annex 10.” This involves “unassigned coding space” as defined in point 3.1.2.3.2.2 of that document. It involves at least one among the following 13 formats: UF1, UF2, UF3, UF6, UF7, UF8, UF9, UF10, UF12, UF13, UF14, UF15 UF23. Out of the 112 bits of the query, 83 bits present between UF and AP fields (the 5 bit UF and 24 bit AP fields being reserved for the basic needs of recognition and integrity of the message in Mode S) are available to convey the data to be transferred. Each query characterizes a data segment or frame transmitted between the maintenance equipment 60 and the onboard computer 10.

From the computer 10 to the equipment 60, the maintenance data are transmitted in mode S using the reserve response formats (unassigned coding space) defined in document “ICAO Annex 10” such as one among the following 13 formats: DF1, DF2, DF3, DF6, DF7, DF8, DF9, DF10, DF12, DF13, DF14, DF15 or DF23. Out of the 112 bits of the response, 83 bits present between DF and P fields (the 5 bit DF and 24 bit P fields being reserved for the elementary needs of recognition and integrity of the Mode S message) are available to convey the data to be transferred. Each response characterizes a data or frame segment transmitted between the onboard computer 10 and the maintenance equipment 60.

According to still another example, the chain 12 includes a mode S level 2 decoder and a data transfer mechanism equivalent to those used during Mode S levels 3 and 4 communication via the query/response exchanges UF24/DF24 (application of the COMM-C/COMM-D protocols defined in the ICAO document Annex 10) in the content of the UFx/DFx exchanges (x representing the reserve format number from among the 13 reserve formats: 1, 2, 3, 6, 7, 8, 9, 10, 12, 13, 14, 15 or 23) thereby enabling a transfer by packet and optimization of the bandwidth. In the equipment 60 to computer 10 direction, typically for file downloading, each query UFx transmitted by the equipment 60 is considered a data segment. The UFx format is structured as follows:
Bit 1 to 5: 5 bit format x
Bit 6 to 7: 2 bit RC field supplies the type of segment to be transferred
Bit 8 to 11: 4 bit NC field provides the segment number (1 to 16) in the packet
Bit 12 to 88: 77 bits useful for the data to be transmitted
Bit 89 to 112: AP field.

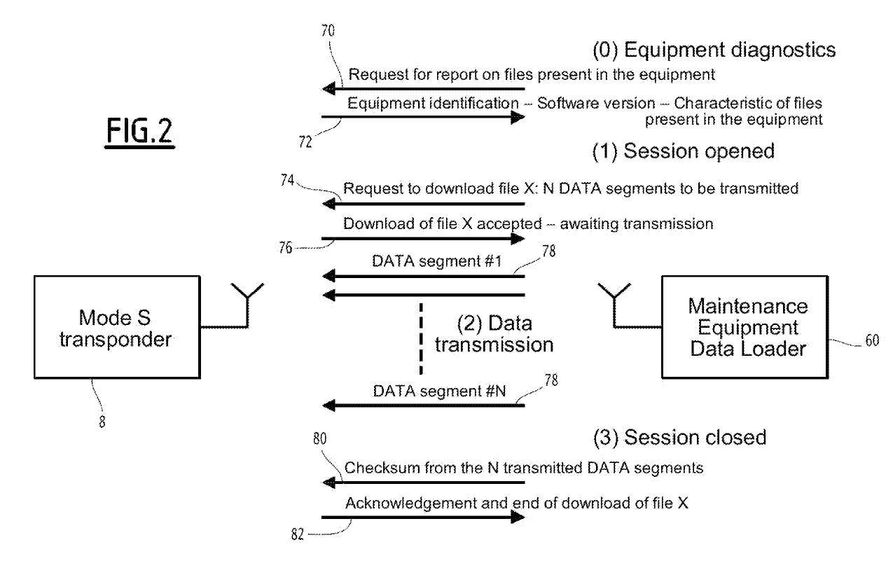

FIG. 2 shows, as an example, the information exchanges through the mode S connection between onboard equipment 8 and the maintenance equipment 60.

After the transmission chain and the processor 10 have been switched into maintenance mode, the maintenance equipment 60 transmits, during a diagnostic phase, a first report request message 70 for the files present in the onboard computer. In a response 72, the onboard computer provides its identification, its software version, and the characteristics of the files present in its configuration.

Through a message 74, the maintenance equipment asks, to start the session, to download a particular file made up of N data segments.

The onboard equipment 8 confirms, through message 76, its acceptance to download the particular file and goes on standby awaiting transmission.

During successive transmissions 78, the maintenance equipment transmits the N segments making up the file.

A session closure phase ends the transmission, the maintenance equipment transmitting a verification message 80, after which the onboard computer sends an acknowledgement message 82 terminating the transaction.

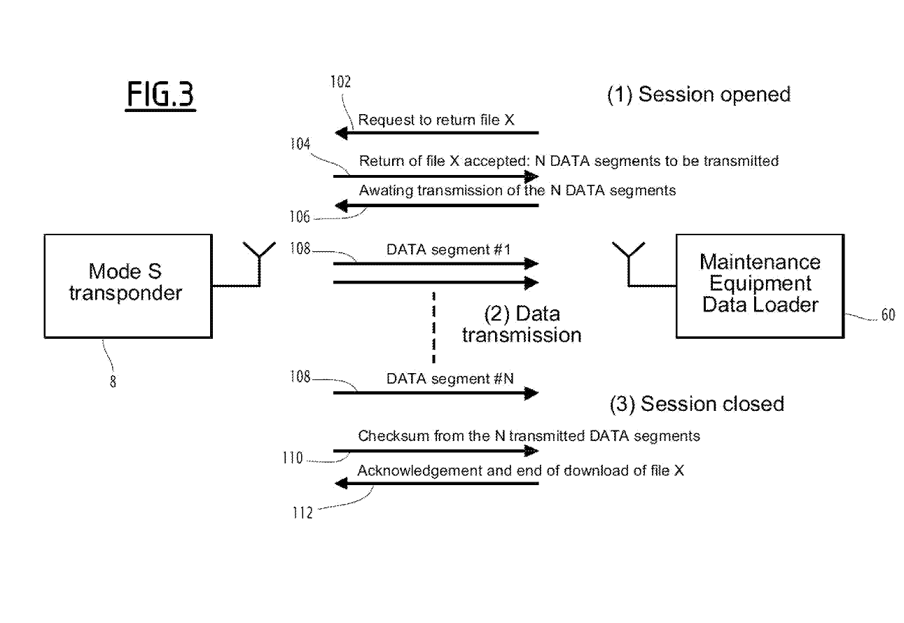

To recover files from the onboard computer, and as illustrated in FIG. 3, the maintenance equipment 60 formulates a request 102 to return a file to open a session, to which the onboard computer 8 returns an acceptance 104 to return the file by indicating the number N of data segments to be transmitted.

The maintenance equipment 106 notifies that it is awaiting transmission of the N segments.

After N transmissions 108, the data segments are transmitted one by one during a data transmission phase.

A verification counter 110 is then sent by the onboard computer to the maintenance equipment, which in 112 sends an acknowledgement, leading to the end of the transaction.

By using such an arrangement, the maintenance of the onboard computer is done simply without it being necessary to connect a connector and therefore access the onboard computer. The cost is reduced by the use of the same mode S connection for the operational exchanges and for maintenance.

According to another aspect of the invention, the operational processing software 18 also comprises a module 18B for allocating, in the table 19, an available registry as defined by the ICAO to a memory address of the computer in response to a predefined request to allocate an available registry.

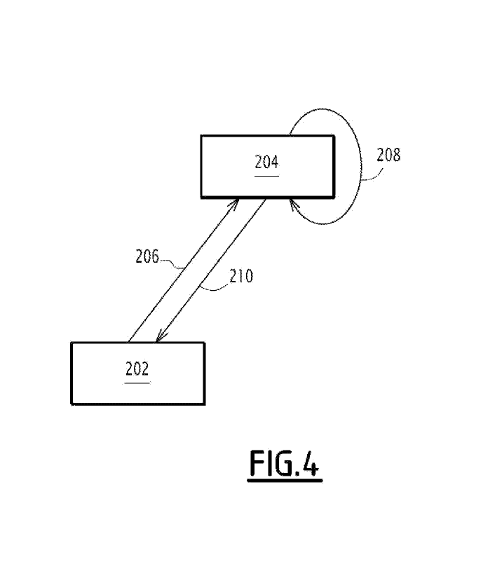

More specifically, and as illustrated in FIG. 4, a piece of monitoring equipment 202 is adapted to create predefined allocation requests and to send them to an onboard computer 204 using the mode S protocol during a transmission 206. These requests have a predefined form described hereinafter.

The module 18B can record the correspondence between the allocated registry and the address in the look-up table 19.

Thus, during normal operation, the module 18A of the onboard computer 204 places, in each identified registry, the value of the address allocated to it in step 208 and sends back to the ground, in the corresponding registry normally available, the value of the corresponding address specified in the table 19 during a descending response message DF denoted 210 in FIG. 4.

The correspondences established between the normally available registries and the addresses can make it possible to carry out a monitoring called “trace” from the ground of the different operating data of the computer normally not monitored by transmitting those data to the ground for analysis in the normally available registries.

These data, whose monitoring is carried out, are essentially of three types:

Basic Data

These data correspond to elements managed by the software. The remote measurement of these data is implemented from their addresses. A map of the memory makes it possible to have that information at any time. This type of operation requires a single programming phase making it possible to manage those traces.

Specific Configurations

These specific configurations are dedicated to TCAS (Traffic Collision Avoidance System) functionalities. This type of remote measurement is also implemented to recover performance information calculated beforehand. This type of operation requires a programming phase to develop each of these specific configurations.

Accounting for Process Occurrences

This involves accounting for the call frequency for certain processes of the software. This type of operation requires a single programming phase making it possible on the one hand to identify the processes that can be monitored and on the other hand to implement the accounting logic.

The module 18A is capable of finding these data after they have been requested from the equipment 60 through a monitoring request at a frequency which is coherent with the query frequency used, for example 50 Hz.

The predefined monitoring request is contained in the 16 bits of the SD sub-fields of the UF free queries, i.e. queries UF 4, UF 5, UF 20 and UF 21.

The 3 bit field DI (Indicator identification) is used to identify the structure of the 16 bit SD sub-field (Special indicator). The values 4, 5 and 6 are not yet assigned by the specification and in particular Annex 10 Vol 4 AOCI §3.1.2.6.1.3 and §3.1.2.6.1.4. As a result, one of these three values is used for remote measuring purposes. This value is configurable and can evolve if necessary.

The content of the SD sub-fields constitutes orders for the module 18A, which handles the execution. Three query modes are provided corresponding to the types of data to be monitored.

Thus, according to a first mode, the values of certain addresses are monitored and sent to the ground at a regular frequency,

To that end, the following 16 bit orders are available:

“Database” Mode: 0001

| | | |
|---|---|---|
| 0001 0000 | 0000 0001 | Identify the trace with number 1 |
| 0001 0001 | 0000 0001 | Eliminate the identified trace 1 |
| 0001 0010 | yyyy yyyy | Enter address (bits 0 to 7) to be monitored for the |
| | | trace |
| 0001 0011 | yyyy yyyy | Enter address (bits 8 to 15) to be monitored for |
| | | the trace |
| 0001 0100 | yyyy yyyy | Enter address (bits 16 to 23) to be monitored for |
| | | the trace |
| 0001 0101 | yyyy yyyy | Enter address (bits 24 to 32) to be monitored for |
| | | the trace |
| 0001 0110 | yyyy yyyy | Enter BDS (*) number chosen for the |
| | | measurement |
| 0001 0111 | yyyy yyyy | Enter field number (1 to 3) for the chosen BDS |
| 0001 1110 | 0000 0001 | Start monitoring of trace number 1 |
| 0001 1111 | 0000 0001 | Stop monitoring of trace number 1 |

(*) the BDS corresponds to one of the many (more than 50 remaining) 32 bit comm-B Data Segment registries not yet assigned among the 256 existing registries.

According to a second mode, the values of a group of addresses are returned to the ground. These groups of addresses each correspond to a configuration. A configuration is a coherent and synchronized set of addressable data, for a given mission of the TCAS type. Each configuration and the corresponding addresses are stored in the computer and the orders ensure the selection of a group. They are, for example:

“Specific Configuration” Mode: 0010

| mode | sub-mode | |
|---|---|---|
| 0010 0000 | 0000 0001 | Identify the config. trace with number 1 |
| 0010 0001 | 0000 0001 | Eliminate the identified config. trace 1 |
| 0010 0010 | yyyy yyyy | Enter config. number to be monitored for the |
| | | trace |
| 0010 0011 | yyyy yyyy | Enter BDS number chosen for the measurement |
| 0010 0100 | yyyy yyyy | Enter field number (1 to 3) for the chosen BDS |
| 0010 1110 | 0000 0001 | Start monitoring of config. trace number 1 |
| 0010 1111 | 0000 0001 | Stop monitoring of config. trace number 1 |

According to a third mode, it is possible to verify the call sequence of one or more processes, a process being a block of instructions, simple or complex. Each process and the instructions that make it up are stored in the computer and the orders ensure the selection of a process. The following orders correspond to the processing to be done for a given trace.

“Process Accounting” Mode: 0011

| | | |
|---|---|---|
| 0011 0000 | 0000 0001 | Identify the process trace with number 1 |
| 0011 0001 | 0000 0001 | Eliminate the process trace identified 1 |
| 0011 0010 | yyyy yyyy | Enter process number to be monitored for the |
| | | trace |
| 0011 0011 | yyyy yyyy | Enter BDS (*) number chosen for remote |
| | | measurement |
| 0011 0100 | yyyy yyyy | Enter field number (1 to 3) for the chosen BDS |
| 0011 1110 | 0000 0001 | Start monitoring for process trace number 1 |
| 0011 1111 | 0000 0001 | Stop monitoring for process trace number 1 |

As an example, the following orders are used to spy on the basic data located at address 0xDCA3 and to refresh with its value the second 16 bit field of the BDS registry number 0x11.
(*) the BDS corresponds to one of the many (more than 50 remaining) 32 bits comm-B Data Segment registries not yet assigned among the 256 existing registries.

Spying on the data situated at address 0xDCA3
0001 0000 0000 0001 Identify trace number
0001 0010 1010 0011 Enter address (bits 0 to 7) to be monitored (0xA3)
0001 0011 1101 1100 Enter address (bits 8 to 15) to be monitored (0xDC)

Refresh the second field of the BDG registry 0x11 with the value of the datum
0001 0110 0001 0001 Enter the chosen BDS number (0x11)
0001 0111 0000 0010 Enter the number of the field 2 of the chosen BDS
0001 1110 0000 0001 Initiate monitoring of trace number 1

From this step, it is possible to:

Eliminate trace 1 (stopping any measurement in progress altogether)
0001 0001 0000 0001 Eliminate trace number 1

Modify trace 1 (stopping any measurement in progress altogether)
Follow the preceding steps

Enter and/or start a new trace (up to 255 possible)
Follow the preceding steps

Stop the monitoring of trace 1 (while keeping the memory of that trace)
0001 1111 0000 0001 Stop the monitoring of trace number 1

Lock the remote measurement mode (stopping and keeping the storage of the current traces)
0011 0011 1100 1100

The values of the addresses, the monitoring of which is ensured, are covered in the available registries of the DF responses and in particular the MB registries of responses DF 20 and DF 21.

This data recovery and the visualization of those data are taken into account to extract Data fields (56 bits) of the Mode S responses type DF20. DF21 or other long DFxx identified as being available in annex 10 of the OACI and by direct visualization via existing devices of the IFR type or recording if necessary.

1. An onboard computer for an airplane, comprising:
a processor carrying out operational functions according to a configuration of the onboard computer;
a memory storing the configuration of the onboard computer;
a parameterization device parameterizing the onboard computer from parameterization information;
a mode S transmission chain as defined by the ICAO for transmitting operational data from the onboard computer to or from a ground station or another airplane, the operational data being processed by the operational functions carried out by the computer,
wherein the transmission chain is able to carry out, in mode S, the transmission of parameterization information, to or from the parameterization device.

2. The onboard computer according to claim 1, wherein the parameterization device of the computer comprises a maintenance device modifying the configuration of the onboard computer and in that the parameterization information is maintenance information sent to or from a maintenance device.

3. The onboard computer according to claim 2, wherein the mode S transmission chain has a transmission rate for the maintenance data higher than the transmission rate for the operational data.

4. The onboard computer according to claim 3, wherein the transmission frequency for mode S maintenance data segments is greater than 100 Hz.

5. The onboard computer according to claim 2, wherein the transmission chain includes a processor having a separate operator processing operational data and maintenance data and in that the onboard computer includes an exclusive activation device, either for the operational data processing device, in an operational mode, or for the maintenance data processing device, in a maintenance mode.

6. The onboard computer according to claim 2, wherein the transmission chain is able to perform level 2 mode S transactions of the COMMA/COMMB type with long queries/responses among the reserve formats defined by the ICAO.

7. The onboard computer according to claim 1, wherein the parameterization device of the computer includes an allocation device allocating, in response to a predefined allocation request, an available registry as defined by the ICAO to a memory address of the computer whereof the value must be sent by the mode S transmission chain as additional operational data contained in the allocated registry and in that the parameterization information is at least one predefined allocation request sent to the allocation device.

8. The onboard computer according to claim 7, wherein the allocation request includes addresses and associated registries and in that the allocation means are able to allocate, the associated registry to each address.

9. The onboard computer according to claim 7, wherein the computer includes a memory for configurations and each configuration specifies a set of addresses of the computer, and in that the allocation request includes an identification of a configuration and an associated registry and in that the allocation device is configured to allocate the associated registry to all of the addresses specified by the configuration such that the simultaneous values of all of the addresses of the configuration are transmitted together in mode S as operational data.

10. The computer according to claim 7, wherein the computer includes a second memory for processes and each process specifies an address of the computer, and in that the allocation request includes an identification of a process and an associated registry and in that the allocation device is configured to allocate the associated registry to the specific identification address of the process so that the value of the address of the process is sent in mode S as operational data.

11. A facility including:
an onboard computer according to claim 1; and
a piece of parameterization equipment configured to communicate, according to a mode S connection, with the onboard computer by exchanging maintenance data.
